(19) United States
(12) Patent Application Publication
(10) Pub. No.: US 2018/0005278 A1
(43) Pub. Date: Jan. 4, 2018

(54) METHOD, DEVICE, BROWSER, ELECTRONIC DEVICE AND SEVER FOR PROVIDING CONTENT INFORMATION

(71) Applicant: GUANGZHOU UCWEB COMPUTER TECHNOLOGY CO., LTD., Guangzhou (CN)

(72) Inventor: Huijuan CHEN, Guangzhou (CN)

(21) Appl. No.: 15/612,227

(22) Filed: Jun. 2, 2017

(30) Foreign Application Priority Data
Jun. 2, 2016 (CN) 201610392132.2

(51) Int. Cl. G06Q 30/02

(52) U.S. Cl. CPC G06Q 30/0271; G06Q 30/0267; G06Q 30/0207; G06Q 30/0255

(57) ABSTRACT

The present invention discloses a content information supplying method, device, browser, electronic device and server. The method for supplying content information comprises: acquiring use information regarding an application; determining a tag corresponding to the application; determining, based on the use information, a first score of the tag; and supplying, based on the first score, content information. On the basis of embodiments of the present invention, determination factors for recommending content information are expanded.

### TECHNICAL FIELD

The present invention relates to the field of content recommendation technologies, and more specifically, to a method, a device, a browser, an electronic device and a server for supplying content information.

### BACKGROUND ART

Along with the development of mobile Internet technologies, people are increasingly dependent on the Internet. As an entrance of access to the Internet for users, browsers are playing an increasingly important role. A browser may be used to guide a user to browse content information. Therefore, how to provide (recommend) valuable content information to users has become an important research topic and an important direction of innovation for technical professionals.

For example, the Chinese Patent Application Publication CN103297498A discloses a method for pushing associated content based on a cell phone client. This Patent Application is incorporated in its entirety herein as reference.

For example, the Chinese Patent Application Publication CN104361085A discloses an information recommendation method, device, browser and system. This Patent Application is incorporated in its entirety herein as reference.

Therefore, there is a need for further improvements of content recommendation technologies.

### SUMMARY OF THE INVENTION

One object of the present invention is to provide a technical solution for supplying content information.

According to a first aspect of the present invention, a method for supplying content information is provided, comprising: acquiring use information regarding an application; determining a tag corresponding to the application; determining, based on the use information, a first score of the tag; and supplying, based on the first score, content information.

Optionally, said use information is a number of times that a user uses the application, and said first score is a product of the number of use times and a first weight.

Optionally, said method further comprises: detecting a keyword searched by the user; recording the number of times that the user searches said keyword; determining a tag corresponding to said keyword; determining, based on the number of search times, a second score of the tag; and supplying, based on the second score, content information.

Optionally, said second score is a product of the number of search times and a second weight.

Optionally, said method further comprises: acquiring website information of a webpage accessed by the user; determining a tag corresponding to said website information; determining, based on the website information, a third score of the tag; and supplying, based on the third score, content information.

Optionally, said website information comprises the number of times that the user accesses said webpage, and said third score is a product of the number of access times and a third weight.

Optionally, content information is supplied based on a sum of the first score, the second score and the third score.

Optionally, said method further comprises: when it is detected that the user becomes a user of an item associated with said tag, determining a fourth score of the tag; and supplying, based on a sum of the first score, the second score, the third score and the fourth score, content information.

Optionally, said content information is the content information recommended to the user.

Optionally, said content information is a webpage or webpage link recommended to the user.

Optionally, said content information is at least one of a webpage associated with said tag, a link address of a webpage associated with said tag, a thumbnail of a webpage associated with said tag, and a keyword associated with said tag.

According to a second aspect of the present invention, a device for supplying content information is provided, comprising: an apparatus configured to acquire use information regarding an application; an apparatus configured to determine a tag corresponding to the application; an apparatus configured to determine, based on the use information, a first score of the tag; and an apparatus configured to supply, based on the first score, content information.

Optionally, said use information is a number of times that a user uses the application, and said first score is a product of the number of use times and a first weight.

Optionally, said device further comprises: an apparatus configured to detect a keyword searched by the user; an apparatus configured to record the number of times that the user searches said keyword; an apparatus configured to determine a tag corresponding to said keyword; an apparatus configured to determine, based on the number of search times, a second score of the tag; and an apparatus configured to supply, based on the second score, content information.

Optionally, said second score is a product of the number of search times and a second weight.

Optionally, said device further comprises: an apparatus configured to acquire website information of a webpage accessed by the user; an apparatus configured to determine a tag corresponding to said website information; an apparatus configured to determine, based on the website information, a third score of the tag; and an apparatus configured to supply, based on the third score, content information.

Optionally, said website information comprises the number of times that the user accesses said webpage, and said third score is a product of the number of access times and a third weight.

Optionally, content information is supplied based on a sum of the first score, the second score and the third score.

Optionally, said device further comprises: an apparatus configured to determine, when it is detected that the user becomes a user of an item associated with said tag, a fourth score of the tag; and an apparatus configured to supply, based on a sum of the first score, the second score, the third score and the fourth score, content information.

Optionally, said content information is the content information recommended to the user.

Optionally, said content information is a webpage or webpage link recommended to the user.

Optionally, said content information is at least one of a webpage associated with said tag, a link address of a webpage associated with said tag, a thumbnail of a webpage associated with said tag, and a keyword associated with said tag.

According to a third aspect of the present invention, a browser is provided, comprising the device according to the present invention and configured to supply the recommended content information to a user.

According to a fourth aspect of the present invention, a browser is provided, which is designed to execute the following operations: acquiring use information regarding an application; determining a tag corresponding to the application; determining, based on the use information, a first score of the tag; and supplying, based on the first score, content information.

Optionally, said browser comprises a search engine field, and said browser is designed to display, when a mouse clicks the input box in said search engine field, said content information, wherein said content information is a search term associated with said tag.

Optionally, said browser comprises a homepage, the homepage comprising an item of today's hot article ranking, and said browser is designed to display said content information in the item of today's hot article ranking, wherein said content information is a link address of a webpage associated with said tag.

Optionally, said browser comprises a homepage, the homepage comprising an item of hot games, and said browser is designed to display said content information in the item of hot games, wherein said content information is a thumbnail of the content of a webpage associated with said tag.

According to a fifth aspect of the present invention, an electronic device is provided, comprising the browser according to the present invention.

According to a sixth aspect of the present invention, an electronic device is provided, comprising a memory and a processor, wherein said memory is configured to store an instruction, and said instruction is used to control said processor to operate to carry out the method according to the present invention.

According to a seventh aspect of the present invention, an electronic device is provided, comprising an acquisition unit configured to acquire use information regarding an application; a determination unit configured to determine a tag corresponding to the application, and determine, based on the use information, a first score of the tag; and a supply unit configured to supply, based on the first score, content information.

According to an eighth aspect of the present invention, a server is provided, comprising a receiving apparatus configured to receive use information regarding an application from a client; a processor configured to determine a tag corresponding to the application, determine a first score of the tag based on the use information, and acquire content information based on the first score; and a sending apparatus configured to send the acquired content information to the client.

According to an embodiment of the present invention, a new mode of recommending content information may be provided, which expands determination factors for recommending content information.

Other features and advantages of the present invention will become clear through the following detailed description of exemplary embodiments of the present invention with reference to the accompanying drawings.

### BRIEF DESCRIPTION OF THE DRAWINGS

The accompanying drawings that are combined in the description and form a part of the description illustrate embodiments of the present invention, and are used, together with the description thereof, to describe the principles of the present invention.

FIG. 1 is a schematic flowchart of a method for supplying content information according to an embodiment of the present invention.

FIG. 2 is a schematic block diagram of a browser according to another embodiment of the present invention.

FIG. 3 is a schematic block diagram of an electronic device according to another embodiment of the present invention.

FIG. 4 is a schematic block diagram of an electronic device according to another embodiment of the present invention.

FIG. 5 is a schematic block diagram of a server according to another embodiment of the present invention.

FIG. 6 is a schematic diagram of a recommendation system according to one example of the present invention.

### DETAILED DESCRIPTION OF THE SPECIFIC EMBODIMENTS

A variety of exemplary embodiments of the present invention will be described in detail with reference to the accompanying drawings. It should be noted that, unless otherwise specifically described, relative arrangements, numerical expressions and numeric values of the parts and steps set forth in these embodiments do not limit the scope of the present invention.

The following description of at least one exemplary embodiment is, in fact, only illustrative, and is not a limitation to the present invention and its application or use in any way.

Detailed discussions may not be made regarding technologies, methods and devices known to those skilled in the art, but in an appropriate situation, said technologies, methods and devices shall be deemed a part of the description.

In all examples illustrated and discussed herein, any specific value shall be construed as being exemplary only, rather than as a limitation. Therefore, other examples of an exemplary embodiment may have different values.

It should be noted that similar numerals and letters represent similar items in the following drawings. Therefore, once an item is defined in a figure, there is no need to provide further discussions on the item in the subsequent figures.

Embodiments and examples of the present invention will be described below with reference to the accompanying drawings.

According to the prior art, factors that are usually considered when recommending content information to a user are factors internal to a browser, without considering the suggestive role of other applications with respect to the recommended content. In one embodiment of the present invention, content information is recommended to a user based on the use of other applications by the user. This provides a new mode of recommending content information, and expands the modes of recommending content information.

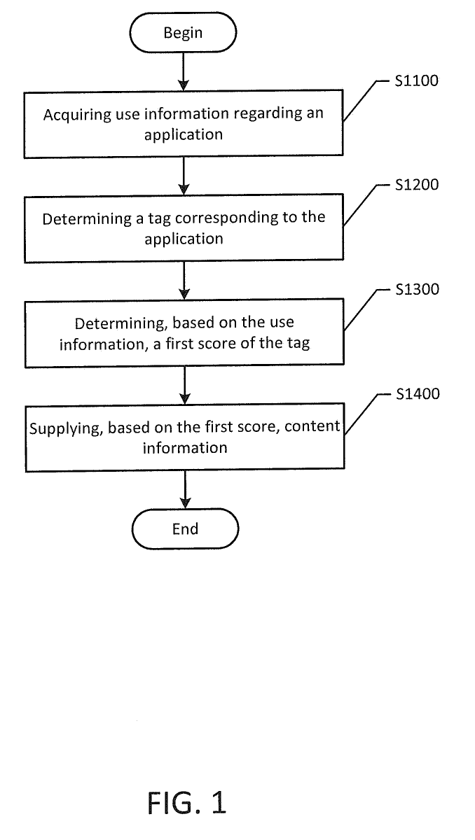

FIG. 1 is a schematic flowchart of a method for supplying content information according to an embodiment of the present invention.

As shown in FIG. 1, Step S1100, acquiring use information regarding an application.

The use information regarding an application may comprise a variety of information related to the use of the application, such as use time, use duration, use interval, use frequency, and the like. Proper use information may be selected by technical professionals according to needs.

In one example, said use information is a number of times that a user uses the application.

Step S1200, determining a tag corresponding to the application.

The tag herein is a factor considered for recommending content information to a user. For example, information to be recommended to the user may be classified in advance. Each classification corresponds to one or more tags. Said tags may be, for example, music, building, basketball, baseball, and the like. Said tags may be set by technical professionals according to needs, or said tags may be generated automatically. How to form said tags is not a focus of the present invention, therefore, more detailed description thereof will not be further provided.

For example, by calculating a score for each tag, content information corresponding to appropriate tags may be determined for recommendation to a user, e.g. the content information corresponding to one or more tags with the highest score.

Step S1300, determining, based on the use information, a first score of the tag.

The score of a tag may relate to factors in a plurality of aspects. A score determined through the use information is used as a first score of the tag herein.

In one example, said use information is a number of times that a user uses the application. In such a case, said first score may be a product of the number of use times and a first weight.

Step S1400, supplying, based on the first score, content information.

Said content information is the content information recommended to the user, which may be in a variety of formats. For example, said content information may be a webpage or webpage link recommended to the user. For example, said content information may be at least one of a webpage associated with said tag, a link address of a webpage associated with said tag, a thumbnail of a webpage associated with said tag, and a keyword associated with said tag.

Usually, relative to the case where a user only randomly browses a content via a browser, the downloading, installation and using of an application by the user indicate that the user is more interested in the content that said application relates to. Therefore, the use information of said application is used as a factor for determining content information to be recommended, which can improve the accuracy of content information recommendation.

Herein, the first score that is determined based on the use information is a factor for determining content information to be recommended. Moreover, the first score may be combined with other factors to further improve the accuracy of content information recommendation.

For example, in one example, a keyword searched by the user is detected; the number of times that the user searches said keyword is recorded; a tag corresponding to said keyword is determined; based on the number of search times, a second score of the tag is determined; and based on the second score, content information is supplied. For example, said second score is a product of the number of search times and a second weight. If the user uses a keyword to search for multiple times, this indicates that the user is relatively interested in information related to said keyword. Therefore, the use of said keyword to recommend content information can improve the recommendation accuracy.

For example, in another example, website information of a webpage accessed by the user is acquired; a tag corresponding to said website information is determined; based on the website information, a third score of the tag is determined; and based on the third score, content information is supplied. For example, said website information comprises the number of times that the user accesses said webpage, and said third score is a product of the number of access times and a third weight. If the user accesses a webpage for multiple times, this indicates that the user is relatively interested in the content of said webpage. Therefore, the recommendation of content information based on the information related to said webpage can improve the recommendation accuracy.

For example, content information may be supplied based on a sum of the first score, the second score and the third score.

In addition to the first score, the second score and the third score above, other factors may be considered for recommending content information, so as to further improve the recommendation accuracy. For example, when it is detected that the user becomes a user of an item associated with said tag, a fourth score of the tag is determined. Said item is, for example, a music item, a basketball item, a baseball item, or a tourism item in the browser. Content information is supplied based on a sum of the first score, the second score, the third score and the fourth score. Generally speaking, the interest that a user has is proportional to the price that he is willing to pay. The registration by a user to become a user of an item indicates that the user is interested in said item. Therefore, the recommendation of content information to a user based on this factor can further improve the recommendation accuracy.

A record file may be used to record at least one of the use information of an application, the number of search times of a keyword, the website information of a webpage accessed by the user, and the user information of an item associated with said tag. Said record file may be stored at a client or a server. During the process of storage, there may be different record files with identical file names. For example, multiple users may share one client apparatus, and all their record files may be stored on said client apparatus. In addition, the record files may be stored on a public server. There may be conflicts among the record files. For example, later files may overwrite the prior files, which leads to data loss.

In addition, there may be identical record files with different file names, which may generate excessive repeated contents on a client apparatus or a server, and form trash files, which take up storage resources of the apparatus or the server.

Therefore, in one example, the hash value of said record file is optionally used as the file name of said record file. In such a way, the above file conflict and/or trash files may be avoided to certain degree.

In addition, in the process of file transmission and/or use, file damages occur frequently. In some cases, if a software program, like a browser, calls a damaged file, it is possible to cause latency and/or collapse of the software program.

Therefore, in another example, before calling said record file to acquire at least one of the use information of an application, the number of search times of a keyword, the website information of a webpage accessed by the user, and the user information of an item associated with said tag, the file name of said record file is used to check the integrity of said record file. In such a way, the above problems can be prevented simply through file names.

In the embodiments of the present invention, the acquired use information, keyword, website information, and user information are not used directly to determine contents to be recommended. In the embodiments, the information is converted to tag information, and content information to be recommended is determined based on the tag information. In such a way, the adverse impact as a result of differences in multiple languages can be mitigated to certain degree. For example, Chinese songs and English songs can both represent the interest of a user in music. However, if content information is recommended only based on a direct keyword (e.g. the title of a Chinese song “Jasmine Flower” or the title of an English song “Marry You”), it might not be able to fully reflect the interest of the user.

In addition, in the case where tags are used, it is very easy to associate a Chinese tag (e.g. “music”) and an English tag (e.g. “music”). As far as this aspect is concerned, therefore, the embodiments of the present invention are more applicable to multilingual applications relative to the prior art.

<Apparatuses>

Those skilled in the art should understand that, in the field of electronic technologies, the above method may be embodied in products by means of software, hardware, or a combination of software and hardware. It would be easy for those skilled in the art to produce, based on the method disclosed above, a device for supplying content information, comprising: an apparatus configured to acquire use information regarding an application; an apparatus configured to determine a tag corresponding to the application; an apparatus configured to determine, based on the use information, a first score of the tag; and an apparatus configured to supply, based on the first score, content information. For example, said use information is a number of times that a user uses the application, and said first score is a product of the number of use times and a first weight

For example, said device further comprises: an apparatus configured to detect a keyword searched by the user; an apparatus configured to record the number of times that the user searches said keyword; an apparatus configured to determine a tag corresponding to said keyword; an apparatus configured to determine, based on the number of search times, a second score of the tag; and an apparatus configured to supply, based on the second score, content information. For example, said second score is a product of the number of search times and a second weight.

For example, said device further comprises: an apparatus configured to acquire website information of a webpage accessed by the user; an apparatus configured to determine a tag corresponding to said website information; an apparatus configured to determine, based on the website information, a third score of the tag; and an apparatus configured to supply, based on the third score, content information. For example, said website information comprises the number of times that the user accesses said webpage, and said third score is a product of the number of access times and a third weight.

For example, content information is supplied based on a sum of the first score, the second score and the third score.

For example, said device further comprises: an apparatus configured to determine, when it is detected that the user becomes a user of an item associated with said tag, a fourth score of the tag; and an apparatus configured to supply, based on a sum of the first score, the second score, the third score and the fourth score, content information.

For example, said content information is the content information recommended to the user. For example, said content information is a webpage or webpage link recommended to the user.

<Browsers>

The device for supplying content information described above may be an independent device (e.g. an application in a client), or may be integrated into a browser and become a part of the browser. In such a case, the browser can achieve more accurate content information recommendation. Those skilled in the art should understand that, along with the technological development, a browser may be an independent application, e.g. the IE browser, Chrome browser and the like, or may be an application integrated with the browser functions, e.g. a Weibo application, a WeChat application, and the like.

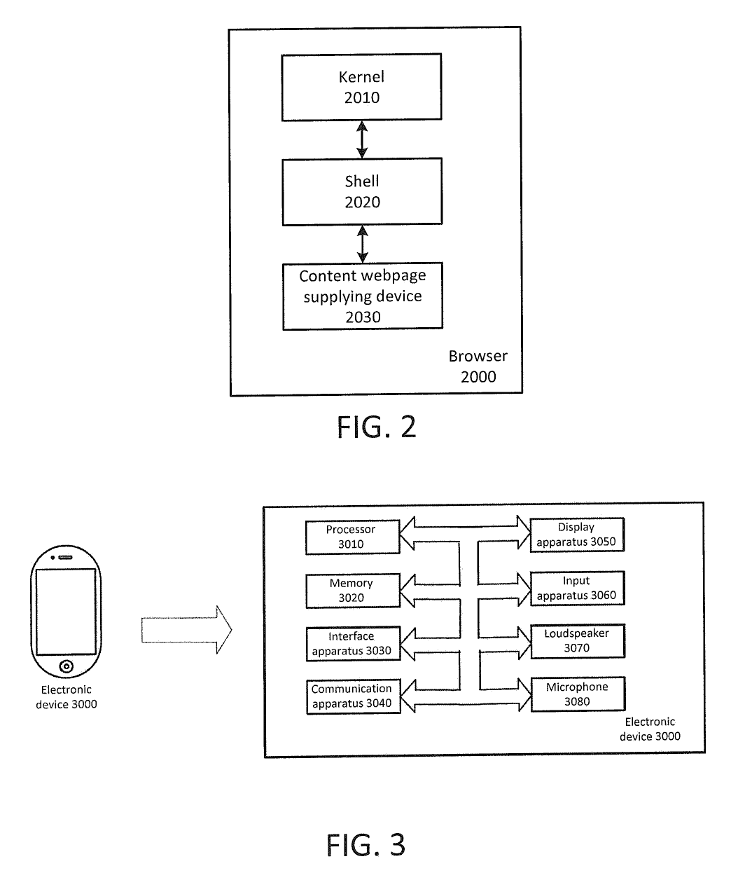

FIG. 2 is a schematic block diagram of a browser according to another embodiment of the present invention.

Generally, a browser may be divided into two parts in architecture, i.e. a kernel and a shell. The browser kernel is responsible for explanation of webpage grammar (e.g. HTML and JavaScript) and rendering (displaying) webpages. Namely, the browser parses and renders webpages through the kernel. The browser shell mainly processes external interface and control experience of the browser. In FIG. 2, the browser 2000 comprises a kernel 2010 and a shell 2020. The browser 2000 further comprises a content webpage supplying device 2030. The content webpage supplying device 2030 may be the device for supplying content information according to the present invention. For the sake of clarity, the content webpage supplying device 2030 is outside of the shell 2020 and the kernel 2010 in FIG. 2. However, those skilled in the art should understand that the content webpage supplying device 2030 may be disposed inside the shell 2020 or the kernel 2010.

On the other hand, it is known to those skilled in the art that, along with the development of electronic information technologies, such as the VLSI technology, and with the tendency of hard software, it is relatively difficult to put a clear boundary between software and hardware of a computer system. That is because any operation may be implemented either by software or by hardware. Any instruction may be executed either by hardware or by software. Whether a hardware implementation solution or a software implementation solution is used for a machine function is dependent on non-technical factors, such as price, speed, reliability, storage capacity, and update cycle. To a person skilled in the field of electronic information technologies, therefore, to describe each operation of a technical solution is a way to more directly and clearly describe said solution. In the case where operations to be executed are known, those skilled in the art can directly design a desired product based on considerations of said non-technical factors. As far as this aspect is concerned, a browser is further provided in the present embodiment, which is designed to execute all operations in the method according to the present invention. For example, said browser is designed to execute the following operations: acquiring use information regarding an application; determining a tag corresponding to the application; determining, based on the use information, a first score of the tag; and supplying, based on the first score, content information.

In one example, said browser comprises a search engine field. A user may input a search term in the search engine field. The browser uses a default or user-defined search engine to search according to the input search term. In this example, said browser is designed to display, when a mouse clicks the input box in said search engine field, said content information, wherein said content information is a search term associated with said tag.

In another example, said browser comprises a homepage. The homepage may be displayed when a user opens the browser, or the homepage may be displayed when a user opens a new tag page. For example, the homepage comprises an item of today's hot article ranking. In this case, said browser is designed to display said content information in the item of today's hot article ranking, wherein said content information is a link address of a webpage associated with said tag. In addition, the homepage may further comprise an item of hot games. In this case, said browser is designed to display said content information in the item of hot games, wherein said content information is a thumbnail of the content of a webpage associated with said tag.

<Electronic Device>

All embodiments of the present invention may be implemented in an electronic device, such that the electronic device can more accurately provide recommended content information to a user. Said electronic device is, for example, a laptop computer, a smart phone, a tablet computer, and the like.

According to one aspect, the electronic device may be an electronic device comprising the browser described above.

According to another aspect, FIG. 3 is a schematic block diagram of an electronic device according to another embodiment of the present invention.

As shown in FIG. 3, the electronic device 3000 may comprise a processor 3010, a memory 3020, an interface apparatus 3030, a communication apparatus 3040, a display apparatus 3050, an input apparatus 3060, a loudspeaker 3070, a microphone 3080, etc.

The processor 3010 may be, for example, a CPU, an MCU, etc. The memory 3020 may be, for example, a ROM (Read-Only Memory), a RAM (Random Access Memories), a non-volatile memory such as hard drive, etc. The interface apparatus 3030 may be, for example, a USB port, an earphone port, etc.

The communication apparatus 3040 may be, for example, capable of wired or wireless communications.

The display apparatus 3050 may be, for example, a LED display, a touchscreen, etc. The input apparatus 3060 may be, for example, a touchscreen, a keyboard, etc. A user may input/output speech information via the loudspeaker 3070 and the microphone 3080.

The electronic device 3000 shown in FIG. 3 is only illustrative, and is not intended to limit the present invention, its application or use in any way.

In the present embodiment, said memory 3020 is configured to store an instruction, and said instruction is used to control said processor 3010 to operate to carry out the method for supplying content information shown in FIG. 1. Those skilled in the art should understand that, although a plurality of apparatuses are shown in FIG. 3, the present invention can only involve a part of the apparatuses thereof, such as the processor 3010 and the memory 3020. Technical professionals may design instructions according to the solution disclosed by the present invention. How the instructions control a processor to operate is well known in the art, which will not be described in detail herein.

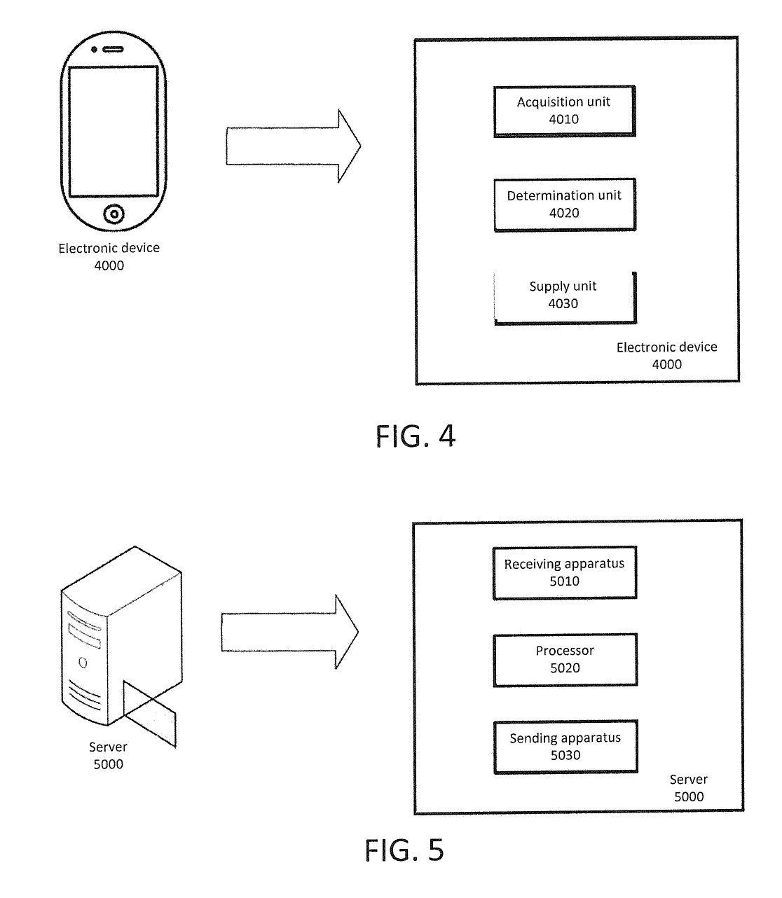

FIG. 4 is a schematic block diagram of an electronic device according to another embodiment of the present invention.

In the present embodiment, said electronic device may be an electronic device like a cell phone or iPad. The electronic device 4000 shown in FIG. 4 comprises an acquisition unit 4010 configured to acquire use information regarding an application; a determination unit 4020 configured to determine a tag corresponding to the application, and determine, based on the use information, a first score of the tag; and a supply unit 4030 configured to supply, based on the first score, content information.

The electronic device 4000 shown in FIG. 4 is only illustrative, and is not intended to limit the present invention, its application or use in any way.

<Servers>

Some processes to determine content information to be recommended may be implemented in a server.

For example, FIG. 5 is a schematic block diagram of a server according to another embodiment of the present invention.

As shown in FIG. 5, the server 5000 comprises a receiving apparatus 5010 configured to receive use information regarding an application from a client; a processor 5020 configured to determine a tag corresponding to the application, determine a first score of the tag based on the use information, and acquire content information based on the first score; and a sending apparatus 5030 configured to send the acquired content information to the client. Said client may be an electronic device described above, or may be an application in an electronic device, such as a browser and the like.

### EXAMPLES

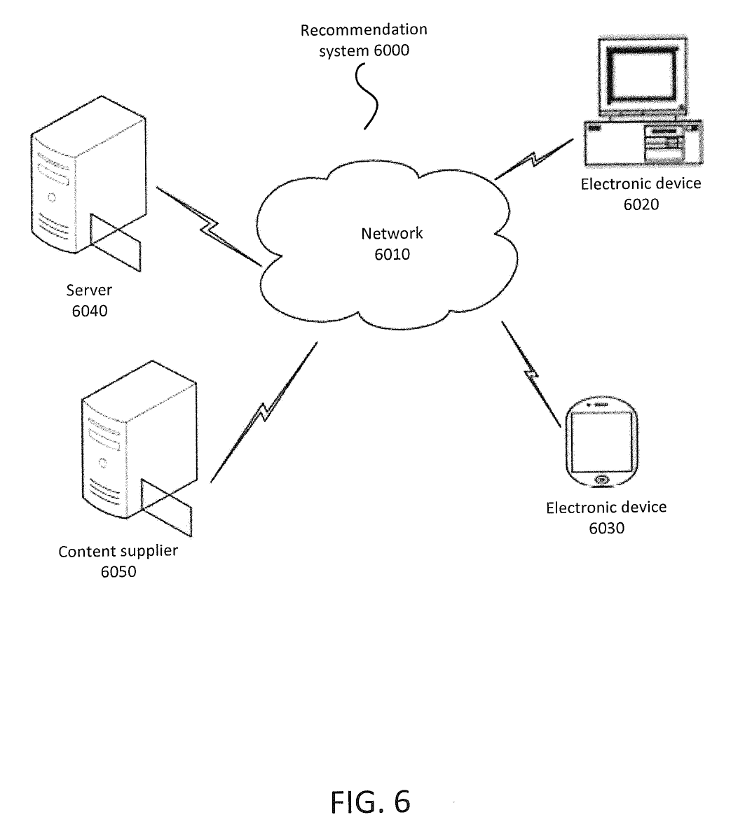

The solution according to the present invention will be described with reference to an example of a recommendation system in FIG. 6.

FIG. 6 is a schematic diagram of a recommendation system according to one example of the present invention.

As shown in FIG. 6, the recommendation system 6000 comprises electronic devices 6020, 6030, a server 6040, and a content supplier 6050.

The electronic devices 6020, 6030 are, for example, a laptop computer, a smart phone, and the like. For example, they may be the electronic device for supplying content information according to the present invention, or may be the electronic device comprising an apparatus or browser for supplying content information according to the present invention.

The electronic devices 6020, 6030 may be used to acquire use information, keyword, website information, or user information. The acquired information may be processed at the electronic devices 6020, 6030 or at the server 6040, so as to determine content information to be recommended to a user. For example, the acquired information may be stored in a record file. Said record file may be stored in the electronic devices 6020, 6030 or in the server 6040. When the content information is determined, for example, the content may be acquired from the content supplier 6050 so as to supply said content to the user, for example, displaying said content on the electronic devices 6020, 6030.

The example in FIG. 6 is only illustrative, and is not a limitation to the present invention in any way.

The technical solution of the present invention may be summarized as follows.

EE1. A method for supplying content information, comprising: acquiring use information regarding an application; determining a tag corresponding to the application; determining, based on the use information, a first score of the tag; and supplying, based on the first score, content information.

EE2. The method according to EE1, wherein said use information is a number of times that a user uses the application, and said first score is a product of the number of use times and a first weight.

EE3. The method according to EE1, further comprising: detecting a keyword searched by the user; recording the number of times that the user searches said keyword; determining a tag corresponding to said keyword; determining, based on the number of search times, a second score of the tag; and supplying, based on the second score, content information.

EE4. The method according to EE3, wherein said second score is a product of the number of search times and a second weight.

EE5. The method according to EE3, further comprising: acquiring website information of a webpage accessed by the user; determining a tag corresponding to said website information; determining, based on the website information, a third score of the tag; and supplying, based on the third score, content information.

EE6. The method according to EE5, wherein said website information comprises the number of times that the user accesses said webpage, and said third score is a product of the number of access times and a third weight.

EE7. The method according to EE5, wherein content information is supplied based on a sum of the first score, the second score and the third score.

EE8. The method according to EE7, further comprising: when it is detected that the EE8. The method according to EE7, further comprising: when it is detected that the user becomes a user of an item associated with said tag, determining a fourth score of the tag; and supplying, based on a sum of the first score, the second score, the third score and the fourth score, content information.

EE9. The method according to EE1, wherein said content information is the content information recommended to the user.

EE10. The method according to EE1, wherein said content information is a webpage or webpage link recommended to the user.

EE11. The method according to EE1, wherein said content information is at least one of a webpage associated with said tag, a link address of a webpage associated with said tag, a thumbnail of a webpage associated with said tag, and a keyword associated with said tag.

EE12. A device for supplying content information, comprising: an apparatus configured to acquire use information regarding an application; an apparatus configured to determine a tag corresponding to the application; an apparatus configured to determine, based on the use information, a first score of the tag; and an apparatus configured to supply, based on the first score, content information.

EE13. The device according to EE12, wherein said use information is a number of times that a user uses the application, and said first score is a product of the number of use times and a first weight.

EE14. The device according to EE12, further comprising: an apparatus configured to detect a keyword searched by the user; an apparatus configured to record the number of times that the user searches said keyword; an apparatus configured to determine a tag corresponding to said keyword; an apparatus configured to determine, based on the number of search times, a second score of the tag; and an apparatus configured to supply, based on the second score, content information.

EE15. The device according to EE14, wherein said second score is a product of the number of search times and a second weight.

EE16. The device according to EE14, further comprising: an apparatus configured to acquire website information of a webpage accessed by the user; an apparatus configured to determine a tag corresponding to said website information; an apparatus configured to determine, based on the website information, a third score of the tag; and an apparatus configured to supply, based on the third score, content information.

EE17. The device according to EE16, wherein said website information comprises the number of times that the user accesses said webpage, and said third score is a product of the number of access times and a third weight.

EE18. The device according to EE16, wherein content information is supplied based on a sum of the first score, the second score and the third score.

EE19. The device according to EE17, further comprising: an apparatus configured to determine, when it is detected that the user becomes a user of an item associated with said tag, a fourth score of the tag; and an apparatus configured to supply, based on a sum of the first score, the second score, the third score and the fourth score, content information.

EE20. The device according to EE12, wherein said content information is the content information recommended to the user.

EE21. The device according to EE12, wherein said content information is a webpage or webpage link recommended to the user.

EE22. The device according to EE12, wherein said content information is at least one of a webpage associated with said tag, a link address of a webpage associated with said tag, a thumbnail of a webpage associated with said tag, and a search term associated with said tag.

EE23. A browser, comprising the device according to EE12 and configured to supply the recommended content information to a user.

EE24. A browser designed to execute the following operations: acquiring use information regarding an application; determining a tag corresponding to the application; determining, based on the use information, a first score of the tag; and supplying, based on the first score, content information.

EE25. The browser according to EE24, wherein said browser comprises a search engine field, and said browser is designed to display, when a mouse clicks the input box in said search engine field, said content information, wherein said content information is a search term associated with said tag.

EE26. The browser according to EE24, wherein said browser comprises a homepage, the homepage comprising an item of today's hot article ranking, and said browser is designed to display said content information in the item of today's hot article ranking, wherein said content information is a link address of a webpage associated with said tag.

EE27. The browser according to EE24, wherein said browser comprises a homepage, the homepage comprising an item of hot games, and said browser is designed to display said content information in the item of hot games, wherein said content information is a thumbnail of the content of a webpage associated with said tag.

EE28. An electronic device, comprising the browser according to EE26 or 27.

EE29. An electronic device, comprising a memory and a processor, wherein said memory is configured to store an instruction, and said instruction is used to control said processor to operate to carry out the method according to EE1.

EE30. An electronic device, comprising: an acquisition unit configured to acquire use information regarding an application; a determination unit configured to determine a tag corresponding to the application, and determine, based on the use information, a first score of the tag; and a supply unit configured to supply, based on the first score, content information.

EE31. A server, comprising: a receiving apparatus configured to receive use information regarding an application from a client; a processor configured to determine a tag corresponding to the application, determine a first score of the tag based on the use information, and acquire content information based on the first score; and a sending apparatus configured to send the acquired content information to the client.

The present invention may be a device, a method and/or a computer program product. The computer program product may comprise a computer readable medium, which is loaded with computer readable program instructions for enabling a processor to implement all aspects of the present invention.

The computer readable medium may be a tangible device capable of maintaining and storing instructions used by an instruction execution device. The computer readable medium may be, for example, but is not limited to, an electric storage device, a magnetic storage device, an optical storage device, an electromagnetic storage device, a semiconductor storage device, or any appropriate combination thereof. A more specific example of the computer readable medium (a non-exhaustive list) comprises: a portable computer disc, a hard drive, a Random Access Memory (RAM), a Read-Only Memory (ROM), an Erasable Programmable Read-Only Memory (EPROM or flash), a Static RAM (SRAM), a Compact Disk Read-Only Memory (CD-ROM), a Digital Versatile Disc (DVD), a memory stick, a floppy disk, a mechanical encoding device, a punch card or a protruding structure in a groove, for example, with instructions stored thereon, and any appropriate combination thereof. The computer readable medium used herein is not interpreted as transient signal itself, such as radio wave or other freely propagating electromagnetic waves, electromagnetic waves propagating through a waveguide or other transmission media (e.g. an optical pulse passing through an optical fiber cable), or electric signals transmitted through electric wires.

The computer readable program instructions described herein may be downloaded from the computer readable medium to each computing/processing device, or downloaded to an external computer or an external storage device via a network, such as the Internet, a Local Area Network, a Wide Area Network, and/or a wireless network. The network may comprise copper transmission cables, optical fiber transmission, wireless transmission, routers, firewalls, switches, gateway computers and/or edge servers. A network adapter card or network interface in each computing/processing device receives computer readable program instructions from the network, and forwards the computer readable program instructions for storage in the computer readable medium of each computing/processing device.

The computer program instructions for executing operations of the present invention may be assembled instructions, Instruction Set Architecture (ISA) instructions, machine instructions, machine-related instructions, micro-codes, firmware instructions, state setting data, or source codes or target codes compiled with any combination of one or more programming languages, said programming languages comprising object oriented programming languages, such as Smalltalk, C++ and the like, and conventional programming languages, such as C language or similar programming languages. The computer readable program instructions can be fully executed on a user computer, partially executed on a user computer, executed as an independent software package, executed partially on a user computer and partially on a remote computer, or executed fully on a remote computer or a server. In the case where a remote computer is involved, the remote computer may be connected to the user computer via any type of network, including LAN or WAN, or may be connected to an external computer (e.g. connected via the Internet by using an Internet service provider). In some embodiments, an electronic circuit, such as a programmable logic circuit, a field-programmable gate array (FPGA) or a programmable logic array (PLA), may be customized according to the state information of the computer readable program instructions, and said electronic circuit can execute the computer readable program instructions to implement all aspects of the present invention.

All aspects of the present invention are described herein with reference to the flowcharts and/or block diagrams of the method, device (system) and computer program product according to the present invention. It should be understood that each block in the flowcharts and/or block diagrams and the combination of the blocks in the flowcharts and/or block diagrams may all be implemented by computer readable program instructions.

These computer readable program instructions may be provided to a general computer, a dedicated computer or processors of other programmable data processing apparatuses, so as to produce a machine such that apparatuses for implementing functions/actions prescribed in one or more blocks in the flowcharts and/or block diagrams are produced when these instructions are executed by the computer or processors of other programmable data processing apparatuses. Alternatively, these computer readable program instructions may be stored in a computer readable medium. These instructions enable the computers, the programmable data processing apparatuses, and/or other devices to work in a specific manner. Therefore, the computer readable medium stored with the instructions comprises a manufactured article, which comprises instructions to implement all aspects of functions/actions prescribed in one or more blocks in the flowcharts and/or block diagrams.

Alternatively, the computer readable program instructions may be loaded to a computer, other programmable data processing apparatuses, or other devices to execute a series of operation steps, so as to generate processes implemented by the computer, such that the instructions executed on the computer, other programmable data processing apparatuses, or other devices implement functions/actions prescribed in one or more blocks in the flowcharts and/or block diagrams.

The flowcharts and block diagrams in the accompanying drawings illustrate system architecture, functions and operations that may be implemented by the system, method, and computer program product in a plurality of embodiments according to the present invention. with respect to this point, each block in the flowcharts or block diagrams may represent one module, or a part of program segment or instructions, and said module or part of program segment or instructions comprises one or more executable instructions for implementing the prescribed logic functions. In some alternative implementations, functions marked in the blocks may also take place in a sequence different from what is indicated in the accompanying drawings. For example, two consecutive blocks may substantially be executed in parallel, and sometimes, they may also be executed in a reverse sequence, which is dependent on the functions involved. It should also be noted that each block in the flowcharts and/or block diagrams and the combination of the blocks in the flowcharts and/or block diagrams may be implemented by a dedicated, hardware-based system for executing the prescribed functions/actions, or may be implemented by a combination of dedicated hardware and computer instructions. It is known to those skilled in the art that the implementation by means of hardware, the implementation by means of software, and the implementation by means of a combination of hardware and software are equivalent.

The embodiments of the present invention have been described above. The above description is exemplary, instead of exhaustive, and is not limited to the disclosed embodiments. Without departing from the scope and spirit of the described embodiments, many modifications and variations would be obvious to those skilled in the art. The terms used herein are selected in such a way that the principles, practical applications of the embodiments, or the technological improvements of the technologies on the market can be explained in the best way, or that others skilled in the art can understand the embodiments disclosed herein. The scope of the present invention is subject to the appended claims.

1. A method for supplying content information, comprising:
acquiring use information regarding an application;
determining a tag corresponding to the application;
determining, based on the use information, a first score of the tag; and
supplying, based on the first score, content information.

2. A device for supplying content information, comprising:
a first apparatus, configured to acquire use information regarding an application;
a second apparatus, configured to determine a tag corresponding to the application;
a third apparatus, configured to determine, based on the use information, a first score of the tag; and
a fourth apparatus, configured to supply, based on the first score, content information.

3. A browser, comprising the device according to claim 2 and configured to supply recommended content information to a user.

4. (canceled)

5. An electronic device, comprising the browser according to claim 4.

6. An electronic device, comprising a memory and a processor, wherein said memory is configured to store an instruction, and said instruction is used to control said processor to operate to carry out the method according to claim 1.

7. (canceled)

8. A server, comprising:
a receiving apparatus, configured to receive use information regarding an application from a client;
a processor, configured to
determine a tag corresponding to the application,
determine a first score of the tag based on the use information, and
acquire content information based on the first score; and
a sending apparatus, configured to send the acquired content information to the client.

9. A browser, configured to perform the method according to claim 1.

10. A device according to claim 2, wherein the first apparatus is an acquisition unit, the fourth apparatus is a supply unit, and a determination unit comprises the second apparatus and the third apparatus.
